(19) United States
(12) Patent Application Publication
(10) Pub. No.: US 2007/0236331 A1
(43) Pub. Date: Oct. 11, 2007

(54) Preventing timeout of RFID tag in timed state of air-interface protocol

(75) Inventors: Leland Thompson, Irvine, CA (US); Omar Khwaja, Irvine, CA (US); Ali Aiouaz, Mission Viejo, CA (US); Christopher J. Diorio, Shoreline, WA (US)

Correspondence Address: MERCHANT & GOULD PC, P.O. BOX 2903, MINNEAPOLIS, MN, 55402-0903, US

(73) Assignee: Impinj, Inc., Seattle, WA (US)

(21) Appl. No.: 11/503,420

(22) Filed: Aug. 11, 2006

Related U.S. Application Data
(60) Provisional application No. 60/786,874, filed on Mar. 29, 2006.

(51) Int. Cl. H04Q 5/22

(52) U.S. Cl. 340/10.1; 340/10.2; 340/572.1; 370/310; 340/10.5

(57) ABSTRACT

An RFID tag can have a state diagram with a timed state that automatically expires after a timeout time. RFID reader systems, software, tags, circuits and methods are provided that send an interim command to cancel the impending automatic expiration.

### RELATED APPLICATIONS

This patent application claims priority from U.S. Provisional Patent Application Ser. No. 60/786,874 filed on 2006 Mar. 29, the disclosure of which is hereby incorporated by reference for all purposes.

### TECHNICAL FIELD

The present description addresses the field of Radio Frequency IDentification (RFID) systems, and more specifically to systems, software and methods for preventing an RFID tag from timing out, when it is in a timed state.

### BACKGROUND

Radio Frequency IDentification (RFID) systems typically include RFID tags and RFID readers (the latter are also known as RFID reader/writers or RFID interrogators). RFID systems can be used in many ways for locating and identifying objects to which the tags are attached. RFID systems are particularly useful in product-related and service-related industries for tracking large numbers of objects being processed, inventoried, or handled. In such cases, an RFID tag is usually attached to an individual item, or to its package.

In principle, RFID techniques entail using an RFID reader to interrogate one or more RFID tags. The reader transmitting a Radio Frequency (RF) wave performs the interrogation. A tag that senses the interrogating RF wave responds by transmitting back another RF wave. The tag generates the transmitted back RF wave either originally, or by reflecting back a portion of the interrogating RF wave in a process known as backscatter. Backscatter may take place in a number of ways.

The reflected-back RF wave may further encode data stored internally in the tag, such as a number. The response is demodulated and decoded by the reader, which thereby identifies, counts, or otherwise interacts with the associated item. The decoded data can denote a serial number, a price, a date, a destination, other attribute(s), any combination of attributes, and so on.

An RFID tag typically includes an antenna system, a power management section, a radio section, and frequently a logical section, a memory, or both. In earlier RFID tags, the power management section included an energy storage device, such as a battery. RFID tags with an energy storage device are known as active tags. Advances in semiconductor technology have miniaturized the electronics so much that an RFID tag can be powered solely by the RF signal it receives. Such RFID tags do not include an energy storage device, and are called passive tags.

RFID readers and tags typically communicate with each other in accordance with an air-interface protocol. An air-interface protocol may be described as a precise and detailed set of rules defining the way in which a reader and tags operate while communicating via radio waves. An air-interface protocol may define the types of commands and responses that may be communicated, as well as the timing requirements for such communications.

A protocol for RFID communication is ordinarily designed for the scenario that an RFID reader encounters a whole group of RFID tags, which is called a population of RFID tags. In addition, it can choose a tag for specially operating on. In some instances, selecting a single tag from the population is called singulation, usually performed for inventorying one tag at a time. In some instances, such a choice is to the exclusion of other, even possibly all, tags in the population.

It is advantageous to design a protocol that defines different internal states for tags. Accordingly, different operations are possible when a tag is in the appropriate internal state. It is up to the reader to issue the appropriate command(s) to bring the tag to the appropriate state, and then possibly issue more command(s) for a desired operation in that state.

In some instances, the protocol is defined so that a tag ordinarily is in a default internal state, and remains there indefinitely until acted upon by a reader. This default internal state is defined as not amenable to the more sensitive or critical operations that a reader can initiate on the tag. To be eligible for such operations, one or more internal states are defined, which are more advanced.

As an added feature, one or more of these advanced internal states can be defined as timed. If the tag is in a timed state and no suitable command is received before the timeout time TTO, the tag “times out”, which means the tag reverts by itself to another state. States that are not timed, such as the original default state, can be thought of as non-timed states, or non-expiring states. The state that the tag reverts to upon timeout can itself be another timed state, or it can be a non-timed state.

An advantage for planning a protocol with some of the states being timed is that a reader does not have to spend communication time commanding a tag to revert to a default state. The reader can instead begin operating on another tag, and leave the first tag to change states upon timeout. Another advantage arises from making the original default state not permit the more sensitive or critical operations, which results in greater robustness, because a tag accidentally left in the advanced state will transition, upon timeout, to the default state.

A challenge arises if more functionality is desired from the reader system. When such functionality is used, the reader issuing a follow-up command to the tag may need to perform additional computations as a result of more considerations.

The challenge, however, arises when such additional functionality requires more time than is allowed by the timeout time of the tag. If more time is indeed spent by the reader, the tag will have timed out, i.e. transitioned away from the timed state, and the follow-up command will not work. The constraint can be more pronounced as data rates become higher, especially if the TTO scales down in inverse proportion with the increasing data rate.

### SUMMARY

RFID reader systems, chips, software, tags, circuits and methods are described for addressing the timeout challenge. In one embodiment, a first tag of a population is caused to transition to a timed state of the protocol, which has a timeout time restriction. Then a first interim command is transmitted, to cause at least one interim result in the first tag, which includes canceling the impending timeout time restriction. Then a follow-up command can be sent as desired.

An advantage over the prior art is that, in some instances, the interim command can thus yield additional time. The additional time can be devoted to further processing, which can result in a system of higher performance and/or robustness, while even at high data rates.

These and other features and advantages of this description will become more readily apparent from the following Detailed Description, which proceeds with reference to the drawings, in which:

### BRIEF DESCRIPTION OF THE DRAWINGS

FIG. 1 is a block diagram of components of an RFID system.

FIG. 2 is a diagram showing components of a passive RFID tag, such as a tag that can be used in the system of FIG. 1.

FIG. 3 is a conceptual diagram for explaining a half-duplex mode of communication between the components of the RFID system of FIG. 1.

FIG. 4 is a block diagram of an implementation of an electrical circuit formed in an IC of the tag of FIG. 2.

FIG. 5A is a state diagram of a tag circuit such as the one of FIG. 4, for complying with a specific communication protocol.

FIG. 5B is a state transition table for one of the states of the diagram of FIG. 5A.

FIG. 5C is a state transition table for another one of the states of the diagram of FIG. 5A.

FIG. 5D is a diagram referred to in the tables of FIG. 5A and FIG. 5B.

FIG. 6 is a block diagram of a whole RFID reader system according to embodiments.

FIG. 7 is a block diagram illustrating an overall architecture of a RFID reader system according to embodiments.

FIG. 8A is a flowchart for illustrating methods for RFID reader systems according to embodiments.

FIG. 8B illustrates a sample processing operation of an embodiment of FIG. 8A.

FIG. 8C illustrates a sample processing operation of another embodiment of FIG. 8A.

FIG. 8D illustrates a sample processing operation of one more embodiment of FIG. 8A.

FIG. 9 is a signal flow diagram resulting from methods of FIG. 8A.

FIG. 10 is a signal flow diagram depicting an example of a flow of FIG. 9, where the interim result is a second response from a tag that is not used.

FIG. 11 is a signal flow diagram depicting an example of a flow of FIG. 9, where the interim result is canceling of a deadline to respond that is not used.

FIG. 12 is a representation for the signal flow diagram of FIG. 11.

FIG. 13 is a flowchart for illustrating methods for RFID chips and tags according to embodiments.

### DETAILED DESCRIPTION

As has been mentioned, the present description is about RFID systems, software and methods. The subject is now described in more detail.

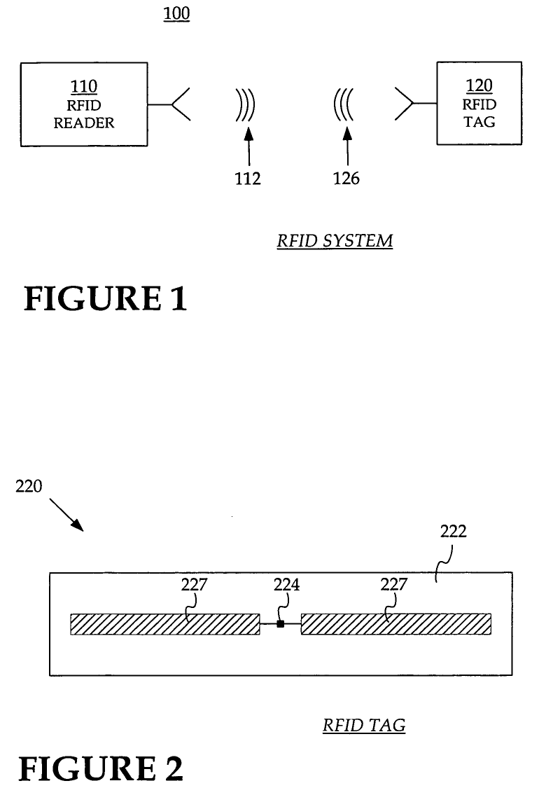

FIG. 1 is a diagram of components of a typical RFID system 100, incorporating aspects of the invention. An RFID reader 110 transmits an interrogating Radio Frequency (RF) wave 112. RFID tag 120 in the vicinity of RFID reader 110 may sense interrogating RF wave 112, and generate wave 126 in response. RFID reader 110 senses and interprets wave 126.

Reader 110 and tag 120 exchange data via wave 112 and wave 126. In a session of such an exchange, each encodes, modulates, and transmits data to the other, and each receives, demodulates, and decodes data from the other. The data is modulated onto, and decoded from, RF waveforms.

Encoding the data in waveforms can be performed in a number of different ways. For example, protocols are devised to communicate in terms of symbols, also called RFID symbols. A symbol for communicating can be a delimiter, a calibration symbol, and so on. Further symbols can be implemented for ultimately exchanging binary data, such as “0” and “1”, if that is desired. In turn, when the waveforms are processed internally by reader 110 and tag 120, they can be equivalently considered and treated as numbers having corresponding values, and so on.

Tag 120 can be a passive tag or an active tag, i.e. having its own power source. Where tag 120 is a passive tag, it is powered from wave 112.

FIG. 2 is a diagram of an RFID tag 220, which can be the same as tag 120 of FIG. 1. Tag 220 is implemented as a passive tag, meaning it does not have its own power source. Much of what is described in this document, however, applies also to active tags.

Tag 220 is formed on a substantially planar inlay 222, which can be made in many ways known in the art. Tag 220 includes an electrical circuit, which is preferably implemented in an integrated circuit (IC) 224. IC 224 is arranged on inlay 222.

Tag 220 also includes an antenna for exchanging wireless signals with its environment. The antenna is usually flat and attached to inlay 222. IC 224 is electrically coupled to the antenna via suitable antenna ports (not shown in this figure).

The antenna may be made in a number of ways, as is well known in the art. In the example of FIG. 2, the antenna is made from two distinct antenna segments 227, which are shown here forming a dipole. Many other embodiments are possible, using any number of antenna segments.

In some embodiments, an antenna can be made with even a single segment. Different places of the segment can be coupled to one or more of the antenna ports of IC 224. For example, the antenna can form a single loop, with its ends coupled to the ports. When the single segment has more complex shapes, it should be remembered that, at the frequencies of RFID wireless communication, even a single segment could behave like multiple segments.

In operation, a signal is received by the antenna, and communicated to IC 224. IC 224 both harvests power, and responds if appropriate, based on the incoming signal and its internal state. To respond, IC 224 modulates the reflectance of the antenna, which generates a backscatter wave from a wave transmitted by the reader. Coupling together and uncoupling the antenna ports of IC 224 can modulate the reflectance, as can a variety of other means.

In the embodiment of FIG. 2, antenna segments 227 are separate from IC 224. In other embodiments, antenna segments may alternately be formed on IC 224, and so on.

The components of the RFID system of FIG. 1 may communicate with each other in any number of modes. One such mode is called full duplex. Another such mode is called half-duplex, and is described below.

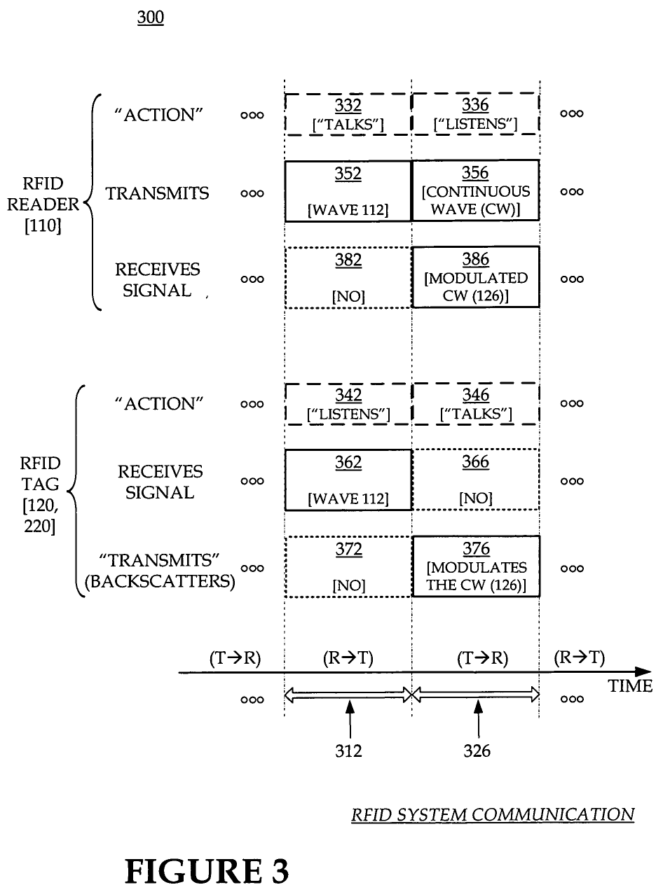

FIG. 3 is a conceptual diagram 300 for explaining the half-duplex mode of communication between the components of the RFID system of FIG. 1, especially when tag 120 is implemented as passive tag 220 of FIG. 2. The explanation is made with reference to a TIME axis, and also to a human metaphor of “talking” and “listening”. The actual technical implementations for “talking” and “listening” are now described.

RFID reader 110 and RFID tag 120 talk and listen to each other by taking turns. As seen on axis TIME, when reader 110 talks to tag 120 the communication session is designated as “R→T”, and when tag 120 talks to reader 110 the communication session is designated as “T→R”. Along the TIME axis, a sample R→T communication session occurs during a time interval 312, and a following sample T→R communication session occurs during a time interval 326. Of course interval 312 is typically of a different duration than interval 326—here the durations are shown approximately equal only for purposes of illustration.

According to blocks 332 and 336, RFID reader 110 talks during interval 312, and listens during interval 326. According to blocks 342 and 346, RFID tag 120 listens while reader 110 talks (during interval 312), and talks while reader 110 listens (during interval 326).

In terms of actual technical behavior, during interval 312, reader 110 talks to tag 120 as follows. According to block 352, reader 110 transmits wave 112, which was first described in FIG. 1. At the same time, according to block 362, tag 120 receives wave 112 and processes it. Meanwhile, according to block 372, tag 120 does not backscatter with its antenna, and according to block 382, reader 110 has no wave to receive from tag 120.

During interval 326, tag 120 talks to reader 110 as follows. According to block 356, reader 110 transmits a Continuous Wave (CW), which can be thought of as a carrier signal that ideally encodes no information. As discussed before, this carrier signal serves both to be harvested by tag 120 for its own internal power needs, and also as a wave that tag 120 can backscatter. Indeed, during interval 326, according to block 366, tag 120 does not receive a signal for processing. Instead, according to block 376, tag 120 modulates the CW emitted according to block 356, so as to generate backscatter wave 126. Concurrently, according to block 386, reader 110 receives backscatter wave 126 and processes it.

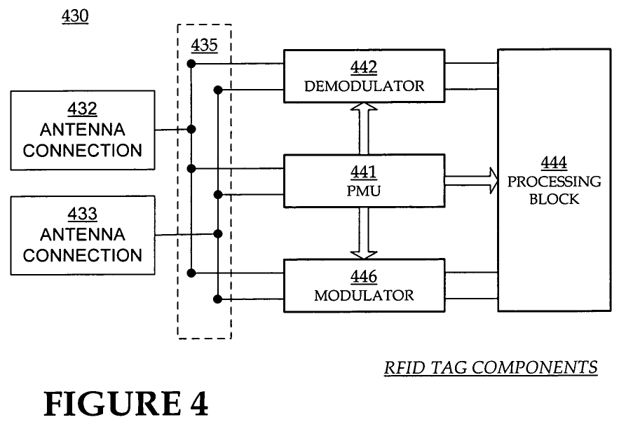

FIG. 4 is a block diagram of an electrical circuit 430. Circuit 430 may be formed in an IC of an RFID tag, such as IC 224 of FIG. 2. Circuit 430 has a number of main components that are described in this document. Circuit 430 may have a number of additional components from what is shown and described, or different components, depending on the exact implementation.

Circuit 430 includes at least two antenna connections 432, 433, which are suitable for coupling to one or more antenna segments (not shown in FIG. 4). Antenna connections 432, 433 may be made in any suitable way, such as pads and so on. In a number of embodiments more than two antenna connections are used, especially in embodiments where more antenna segments are used.

Circuit 430 includes a coupling section 435. Section 435 may be implemented as shown, for example as a group of nodes for proper routing of signals. In some embodiments, section 435 may be implemented otherwise, for example to include a receive/transmit switch that can route a signal, and so on.

Circuit 430 also includes a Power Management Unit (PMU) 441. PMU 441 may be implemented in any way known in the art, for harvesting raw RF power received via antenna connections 432, 433. In some embodiments, PMU 441 includes at least one rectifier, and so on.

In operation, an RF wave received via antenna connections 432, 433 is received by PMU 441, which in turn generates power for components of circuit 430. This is true for either or both of R→T sessions (when the received RF wave carries a signal) and T→R sessions (when the received RF wave carries no signal).

Circuit 430 additionally includes a demodulator 442. Demodulator 442 demodulates an RF signal received via antenna connections 432, 433. Demodulator 442 may be implemented in any way known in the art, for example including an attenuator stage, amplifier stage, and so on.

Circuit 430 further includes a processing block 444. Processing block 444 receives the demodulated signal from demodulator 442, and may perform operations. In addition, it may generate an output signal for transmission.

Processing block 444 may be implemented in any way known in the art. For example, processing block 444 may include a number of components, such as a processor, a memory, a decoder, an encoder, and so on.

Circuit 430 additionally includes a modulator 446. Modulator 446 modulates an output signal generated by processing block 444. The modulated signal is transmitted by driving antenna connections 432, 433, and therefore driving the load presented by the coupled antenna segment or segments. Modulator 446 may be implemented in any way known in the art, for example including a driver stage, amplifier stage, and so on.

In one embodiment, demodulator 442 and modulator 446 may be combined in a single transceiver circuit. In another embodiment, modulator 446 may include a backscatter transmitter or an active transmitter. In yet other embodiments, demodulator 442 and modulator 446 are part of processing block 444. In terms of processing a signal, circuit 430 operates differently during a R→T session and a T→R session.

It will be recognized at this juncture that circuit 430 can also be the circuit of an RFID reader according to the invention, without needing PMU 441. Indeed, an RFID reader can typically be powered differently, such as from a wall outlet, a battery, and so on. Additionally, when circuit 430 is configured as a reader, processing block 444 may have additional Inputs/Outputs (I/O) to a terminal, network, or other such devices or connections.

The logical layer of a communication protocol often includes a state diagram. The state diagram defines the logical states that a circuit (and its tag) must comply with to be compatible with the protocol. As mentioned above, some of these states can be timed, while others can be non-timed.

Circuits such as circuit 430, and, in particular, processing block 444, can be characterized by the state diagram that is called for by the protocol. For example, processing block 444 may include a state machine which implements the state diagram. Accordingly, a reader communicates with a tag by sending signals to control the state of the tag.

It will be apparent the invention is applicable regardless of the protocol used. Indeed, many protocols can define states that are timed and states that are non-timed.

In the Description, a specific protocol is used as an example only, which is called the Specification for RFID Air-interface—EPC™ Radio-Frequency Identity Protocols Class-1 Generation-2 UHF RFID Protocol for Communications at 860 MHz-960 MHz, which is also colloquially known as “the Gen2 Spec” or just “Gen2”. The Gen2 Spec has been ratified by EPCglobal, which is an organization that maintains a website at: <http://www.epcglobalinc.org/> at the time this document is initially filed with the USPTO. The Gen2 spec is incorporated in this description in its entirety, and in fact specific aspects of it such as commands etc. are used in this document.

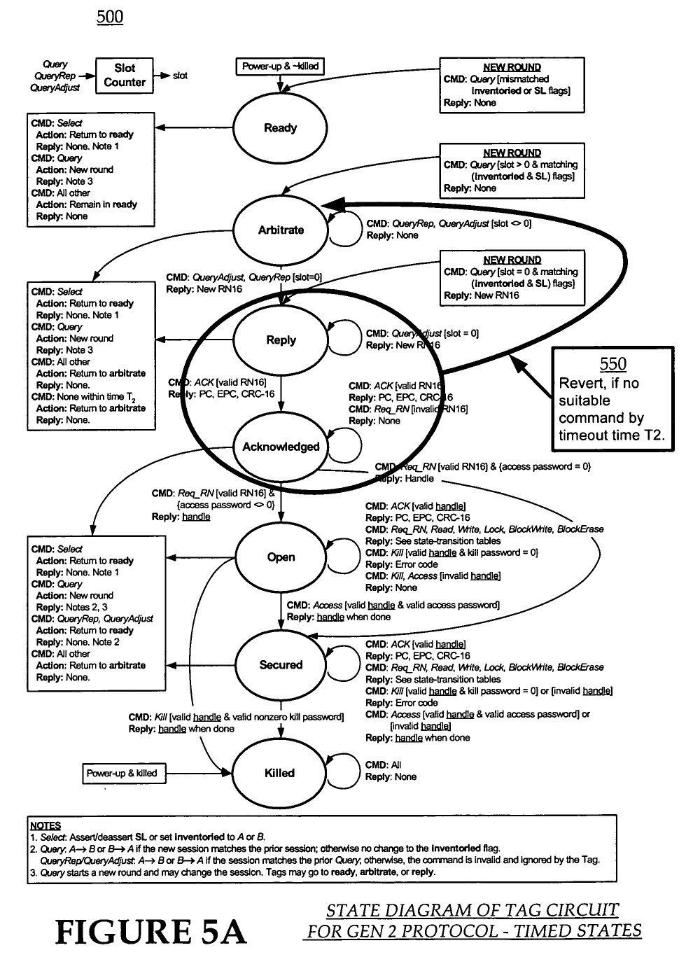

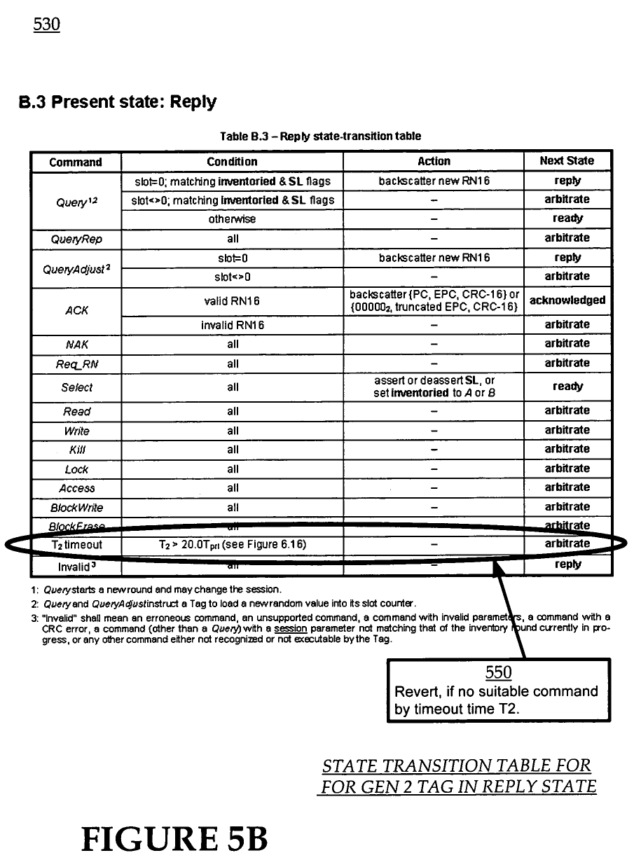

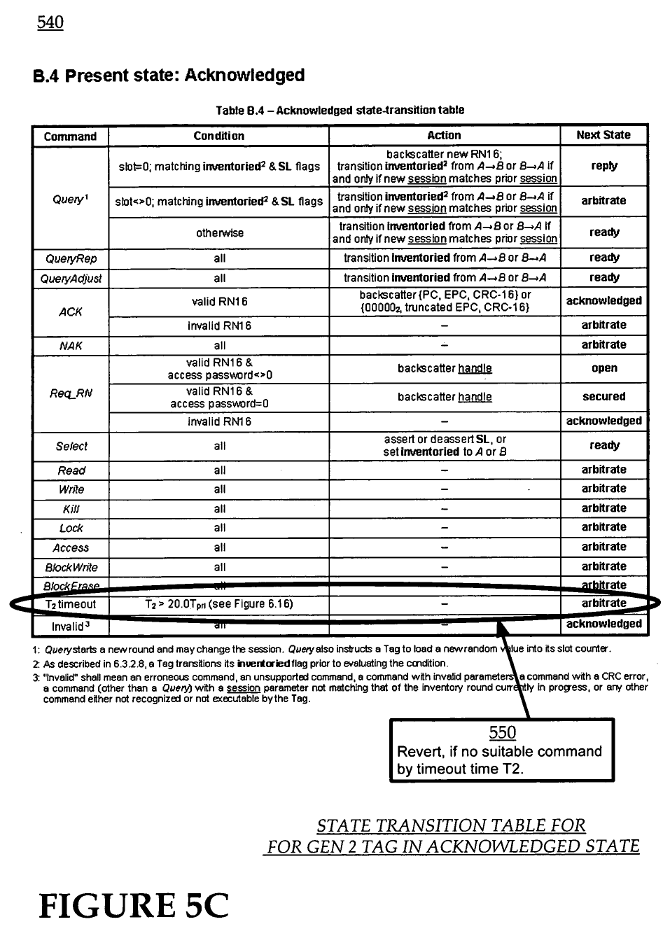

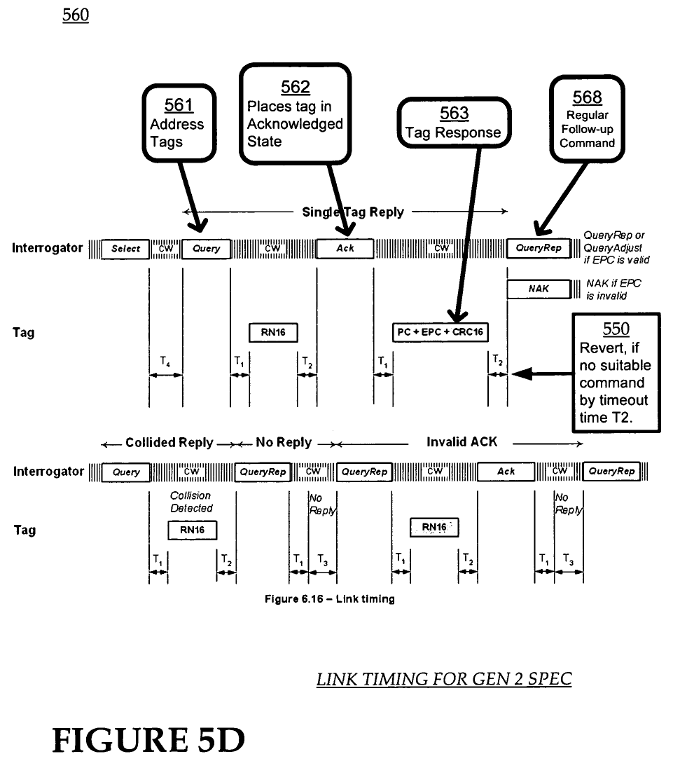

FIG. 5A is a state diagram 500 that a tag circuit, such as circuit 430, must comply with, so that it (and its tag) are compatible with the Gen 2 Spec. The internal states of state diagram 500 are Ready, Arbitrate, Reply, Acknowledged, Open, Secured and Killed. State diagram 500 also includes information about the tag behavior, abbreviated for quick reference.

The transitions between the states of diagram 500 are delineated exactly in Annex B of the Gen2 Spec. Two of the pages of that Annex are replicated in the present document. In particular, FIG. 5B has a diagram 530 showing the state transition table for when the tag is in the Reply state, and FIG. 5C has a diagram 540 showing the state transition table for when the tag is in the Acknowledged state.

Referring to FIGS. 5A, 5B and 5C, as per a comment 550, if a Gen 2 compliant tag is in either the Reply state or the Acknowledged state, it will revert to the Arbitrate state if it does not receive a suitable command before timeout time T2. As such the Reply state and the Acknowledged state can be considered to be timed states, while the Arbitrate state can be considered to be a non-timed state.

FIG. 5D is a diagram 560, illustrating a diagram of the Gen2 Spec that is referred to in the tables of FIG. 5B and FIG. 5C. Diagram 560 shows an interchange of reader commands and tag responses for inventorying tags. The upper portion is for a single tag replying to a reader.

The reader may send a Query command 561 to address tags, causing none, one, or more than one tag to reply. When a single tag replies with an RN16, the reader can transmit an ACK command 562, which places the tag in the Acknowledged state. The tag responds with a code 563, and the reader sends a regular follow-up command 568, for addressing another tag.

Since the Acknowledged state is a timed state, the reader has only time T2 to begin transmitting command 568, after code 563 has finished being backscattered. This time limit can be a challenge, if it is desired to process code 563, and maybe decide to access the tag, before proceeding to address another tag.

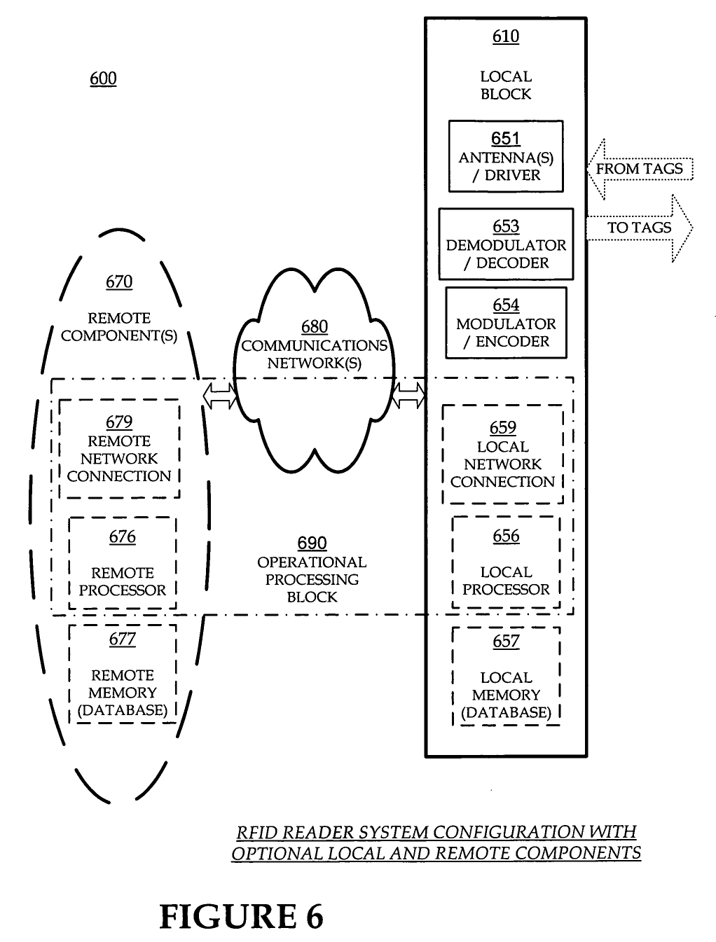

FIG. 6 is a block diagram of a whole RFID reader system 600 according to embodiments. System 600 includes a local block 610, and optionally remote components 670. Local block 610 and remote components 670 can be implemented in any number of ways. It will be recognized that reader 110 of FIG. 1 is the same as local block 610, if remote components 670 are not provided. Alternatively, reader 110 can be implemented instead by system 600, of which only the local block 610 is shown in FIG. 1.

Local block 610 is responsible for communicating with tags. Local block 610 includes a block 651 of an antenna and a driver of the antenna for communicating with the tags. Some readers, like that shown in local block 610, contain a single antenna and driver. Some readers contain multiple antennas and drivers and a method to switch signals among them, including sometimes using different antennas for transmitting and for receiving. And some readers contain multiple antennas and drivers that can operate simultaneously. A demodulator/decoder block 653 demodulates and decodes backscattered waves received from the tags via antenna block 651. Modulator/encoder block 654 encodes and modulates an RF wave that is to be transmitted to the tags via antenna block 651.

Local block 610 additionally includes an optional local processor 656. Processor 656 may be implemented in any number of ways known in the art. Such ways include, by way of examples and not of limitation, digital and/or analog processors such as microprocessors and digital-signal processors (DSPs); controllers such as microcontrollers; software running in a machine such as a general purpose computer; programmable circuits such as Field Programmable Gate Arrays (FPGAs), Field-Programmable Analog Arrays (FPAAs), Programmable Logic Devices (PLDs), Application Specific Integrated Circuits (ASIC), any combination of one or more of these; and so on. In some cases some or all of the decoding function in block 653, the encoding function in block 654, or both, may be performed instead by processor 656.

Local block 610 additionally includes an optional local memory 657. Memory 657 may be implemented in any number of ways known in the art. Such ways include, by way of examples and not of limitation, nonvolatile memories (NVM), readonly memories (ROM), random access memories (RAM), any combination of one or more of these, and so on. Memory 657, if provided, can include programs for processor 656 to run, if provided.

In some embodiments, memory 657 stores data read from tags, or data to be written to tags, such as Electronic Product Codes (EPCs), Tag Identifiers (TIDs) and other data. Memory 657 can also include reference data that is to be compared to the EPC codes, instructions and/or rules for how to encode commands for the tags, modes for controlling antenna 651, and so on. In some of these embodiments, local memory 657 is provided as a database.

Some components of local block 610 typically treat the data as analog, such as the antenna/driver block 651. Other components such as memory 657 typically treat the data as digital. At some point there is a conversion between analog and digital. Based on where this conversion occurs, a whole reader may be characterized as “analog” or “digital”, but most readers contain a mix of analog and digital functionality.

If remote components 670 are indeed provided, they are coupled to local block 610 via an electronic communications network 680. Network 680 can be a Local Area Network (LAN), a Metropolitan Area Network (MAN), a Wide Area Network (WAN), a network of networks such as the internet, and so on. In turn, local block 610 then includes a local network connection 659 for communicating with network 680.

There can be one or more remote component(s) 670. If more than one, they can be located at the same place with each other, or in different places. They can access each other and local block 610 via network 680, or via other similar networks, and so on. Accordingly, remote component(s) 670 can use respective remote network connections. Only one such remote network connection 679 is shown, which is similar to local network connection 659, etc.

Remote component(s) 670 can also include a remote processor 676. Processor 676 can be made in any way known in the art, such as was described with reference to local processor 656.

Remote component(s) 670 can also include a remote memory 677. Memory 677 can be made in any way known in the art, such as was described with reference to local memory 657. Memory 677 may include a local database, and a different database of a Standards Organization, such as one that can reference EPCs.

Of the above-described elements, it is advantageous to consider a combination of these components, designated as operational processing block 690. Block 690 includes those that are provided of the following: local processor 656, remote processor 676, local network connection 659, remote network connection 679, and by extension an applicable portion of network 680 that links connection 659 with connection 679. The portion can be dynamically changeable, etc. In addition, block 690 can receive and decode RF waves received via antenna 651, and cause antenna 651 to transmit RF waves according to what it has processed.

Block 690 includes either local processor 656, or remote processor 676, or both. If both are provided, remote processor 676 can be made such that it operates in a way complementary with that of local processor 656. In fact, the two can cooperate. It will be appreciated that block 690, as defined this way, is in communication with both local memory 657 and remote memory 677, if both are present.

Accordingly, block 690 is location agnostic, in that its functions can be implemented either by local processor 656, or by remote processor 676, or by a combination of both. Some of these functions are preferably implemented by local processor 656, and some by remote processor 676. Block 690 accesses local memory 657, or remote memory 677, or both for storing and/or retrieving data.

Reader system 600 operates by block 690 generating communications for RFID tags. These communications are ultimately transmitted by antenna block 651, with modulator/encoder block 654 encoding and modulating the information on an RF wave. Then data is received from the tags via antenna block 651, demodulated and decoded by demodulator/decoder block 653, and processed by processing block 690.

The invention also includes methods. Some are methods of operation of an RFID reader or RFID reader system. Others are methods for controlling an RFID reader or RFID reader system.

These methods can be implemented in any number of ways, including using the structures described in this document. One such way is by machine operations, using devices of the type described in this document.

Another optional way is for some of the individual operations of the methods to be performed by machine, in conjunction with one or more human operators performing some. These human operators need not be collocated with each other, and each can be with a machine that performs a portion of the method.

The invention additionally includes programs, and methods of operation of the programs. A program is generally defined as a group of steps or operations leading to a desired result, due to the nature of the elements in the steps and their sequence. A program is usually advantageously implemented as a sequence of steps or operations for a processor, such as is described above.

Performing the steps, instructions, or operations of a program requires manipulation of physical quantities. Usually, though not necessarily, these quantities may be transferred, combined, compared, and otherwise manipulated or processed according to the steps or instructions, and they may also be stored in a computer-readable medium. These quantities include, for example, electrical, magnetic, and electromagnetic charges or particles, states of matter, and in the more general case can include the states of any physical devices or elements. It is convenient at times, principally for reasons of common usage, to refer to information represented by the states of these quantities as bits, data bits, samples, values, symbols, characters, terms, numbers, or the like. It should be borne in mind, however, that all of these and similar terms are associated with the appropriate physical quantities, and that these terms are merely convenient labels applied to these physical quantities, individually or in groups.

The invention furthermore includes storage media. Such media, individually or in combination with others, have stored thereon instructions of a program made according to the invention. A storage medium according to the invention is a computer-readable medium, such as a memory, and is read by a processor of the type mentioned above. If a memory, it can be implemented in a number of ways, such as Read Only Memory (ROM), Random Access Memory (RAM), etc., some of which are volatile and some nonvolatile.

Even though it is said that the program may be stored in a computer-readable medium, it should be clear to a person skilled in the art that it need not be a single memory, or even a single machine. Various portions, modules or features of it may reside in separate memories, or even separate machines. The separate machines may be connected directly, or through a network such as a local access network (LAN) or a global network such as the Internet. Plus, some of these machines can be chips with the software embedded.

Often, for the sake of convenience only, it is desirable to implement and describe a program as software. The software can be unitary, or thought in terms of various interconnected distinct software modules.

This detailed description is presented largely in terms of flowcharts, algorithms, and symbolic representations of operations on data bits on and/or within at least one medium that allows computational operations, such as a computer with memory. Indeed, such descriptions and representations are the type of convenient labels used by those skilled in programming and/or the data processing arts to effectively convey the substance of their work to others skilled in the art. A person skilled in the art of programming may use these descriptions to readily generate specific instructions for implementing a program according to the present invention.

Embodiments of an RFID reader system can be implemented as a combination of hardware and software. It is advantageous to consider such a system as subdivided into components or modules. A person skilled in the art will recognize that some of these components or modules can be implemented as hardware, some as software, some as firmware, and some as a combination. An example of such a subdivision is now described.

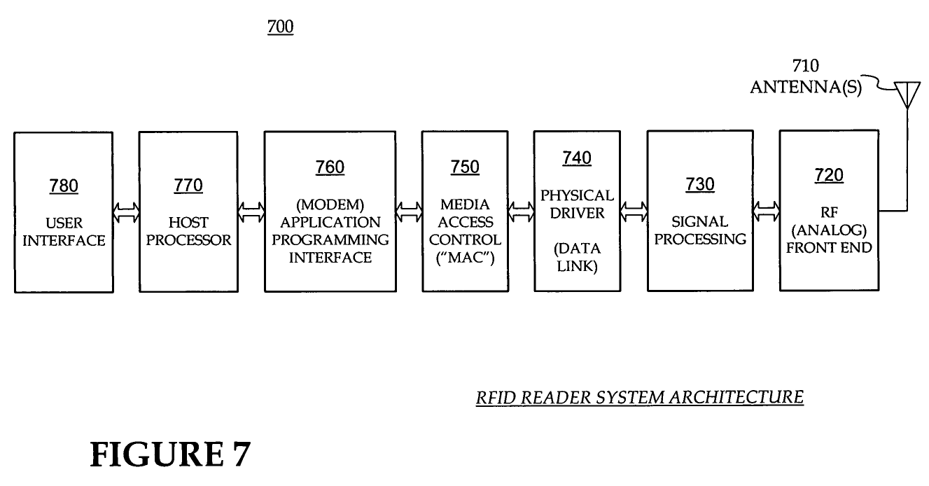

FIG. 7 is a block diagram illustrating an overall architecture of a RFID reader system 700 according to embodiments. It will be appreciated that system 700 is considered subdivided into modules or components. Each of these modules may be implemented by itself, or in combination with others. It will be recognized that some aspects are parallel with those of FIG. 6. In addition, some of them may be present more than once.

RFID reader system 700 includes one or more antennas 710, and an RF Front End 720, for interfacing with antenna(s) 710. These can be made as described above. In addition, Front End 720 typically includes analog components.

System 700 also includes a Signal Processing module 730. In one embodiment, module 730 exchanges waveforms with Front End 720, such as I and Q waveform pairs. In some embodiments, signal processing module 730 is implemented by itself as a separate module; in other embodiments, module 730 may be combined with modules 720 or 740, or split between them.

System 700 also includes a Physical Driver module 740, which is also known as a Data Link. In one embodiment, module 740 exchanges bits with module 730. Data Link 740 can be the stage associated with framing of data. In one embodiment, module 740 is implemented by a Digital Signal Processor.

System 700 additionally includes a Media Access Control module 750, which is also known as a MAC layer. In one embodiment, module 750 exchanges packets of bits with module 740. MAC layer 750 can make decisions for using the wireless communication medium, which in this case is the air-interface. Using can be between reader system 700 and tags, or between system 700 and another reader, or between tags, or a combination. In one embodiment, module 750 is implemented by a Digital Signal Processor.

System 700 moreover includes an Application Programming Interface module 760, which is also known as API, Modem API, and MAPI. In some embodiments, module 760 is itself an interface for a user.

System 700 further includes a host processor 770. Processor 770 exchanges signals with MAC layer 750 via module 760. In some embodiments, host processor 770 is not considered as a separate module, but one that includes some of the above-mentioned modules of system 700. A user interface 780 is coupled to processor 770, and it can be manual, automatic, or both.

Host processor 770 can include applications for system 700. In some embodiments, elements of module 760 may be distributed between processor 770 and MAC layer 750.

It will be observed that the modules of system 700 form something of a chain. Adjacent modules in the chain can be coupled by the appropriate instrumentalities for exchanging signals. These instrumentalities include conductors, buses, interfaces, and so on. These instrumentalities can be local, e.g. to connect modules that are physically close to each other, or over a network, for remote communication.

The chain is used in opposite directions for receiving and transmitting. In a receiving mode, wireless waves are received by antenna(s) 710 as signals, which are in turn processed successively by the various modules in the chain. Processing can terminate in any one of the modules. In a transmitting mode, initiation can be in any one of these modules. That which is to be transmitted becomes signals for antenna(s) 710 to transmit as wireless waves.

The architecture of system 700 is presented for purposes of explanation, and not of limitation. Its particular subdivision into modules need not be followed for creating embodiments according to the invention. Furthermore, the features of the invention can be performed either within a single one of the modules, or by a combination of them.

An economy is achieved in the present document in that a single set of flowcharts is used to describe methods in and of themselves, along with operations of hardware and/or software. This is regardless of how each element is implemented.

Methods are now described more particularly.

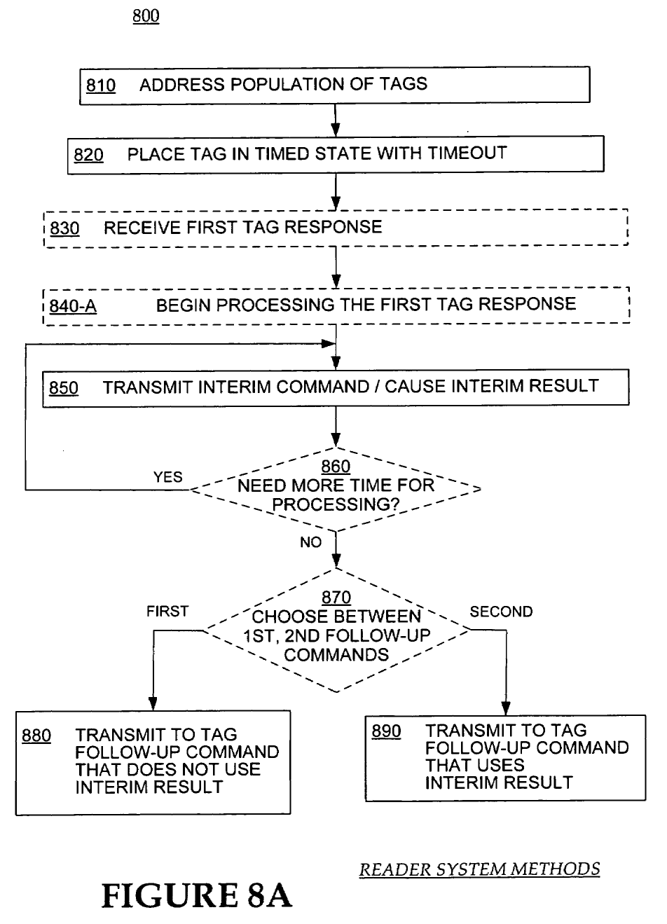

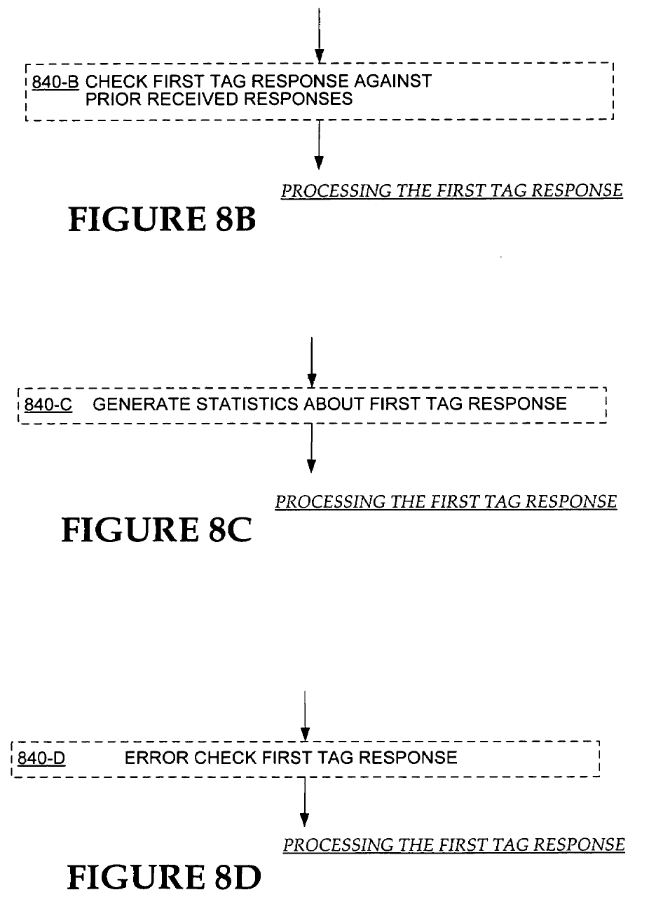

FIG. 8A shows a flowchart 800 for describing methods for RFID reader systems according to embodiments. The methods of flowchart 800 may also be practiced by physical and hardware embodiments of RFID reader systems as described above.

According to an operation 810, a population of RFID tags is addressed in accordance with an air-interface protocol. Addressing can be performed by transmitting any number of commands. For example, a command can select a group or subgroup of the population, or prepare it for being inventoried. In particular, for embodiments of the Gen2 Spec, such commands would be a Select command, a Query command, and so on.

According to a next operation 820, a first tag of the population is caused to transition to a timed state of the protocol. A timed state for this document means a state for which there is a timeout condition, namely that the tag is set to make a default reversion to another state if it does not receive a suitable (by the protocol) follow-up command within a preset timeout time TTO.

For the particular example where the protocol is Gen 2, the timed state can be the Reply state or the Acknowledged state, and the other state to which the tag reverts can be the Arbitrate state. These states were described above in connection with FIGS. 5A, 5B, 5C.

According to an optional operation 830, a first tag response is received by the reader. In some embodiments, the first tag response is received as a consequence of the addressing operation 810. In some embodiments, the tag transitions to the timed state concurrently with transmitting (and receiving at the reader) the first tag response.

The first tag response can be any response from the tag. For example, it can be a backscattered tag code. For the particular example where the protocol is Gen 2, the backscattered tag code can include a protocol control (PC) word, a random number, an Electronic Product Code (EPC) of the first tag, and so on. By “random number” in this document, it is meant both truly random numbers and also pseudo-random numbers.

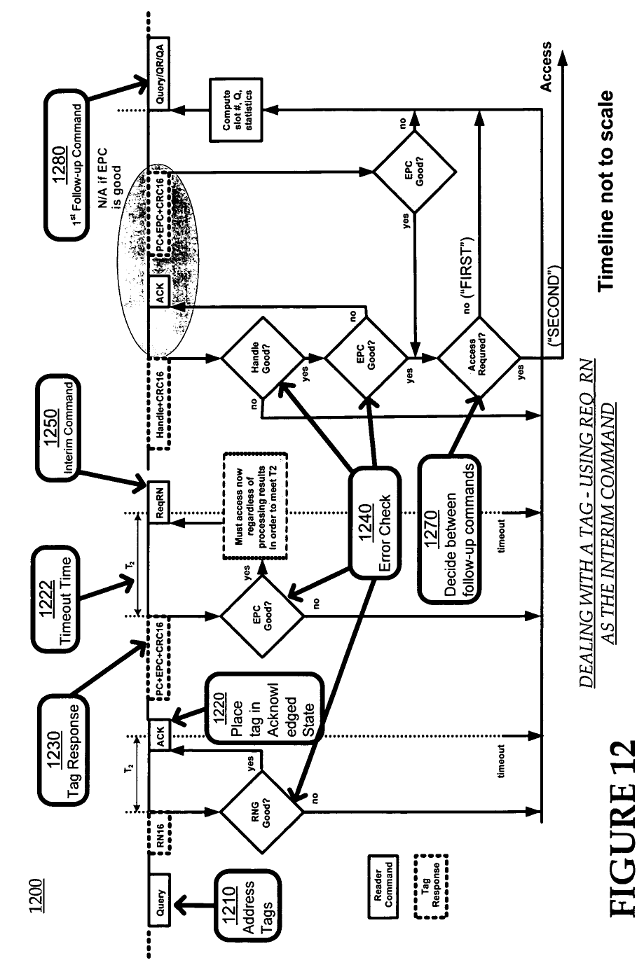

According to an optional operation 840-A, processing of the first tag response begins. This is described in more detail later in this document. In addition, a working example is given at FIG. 12.

Processing can require more time than is permitted by the timeout condition. According to embodiments, the time condition is removed, which can be accomplished in a number of ways. For example, one or more commands can cause this first tag to transition to another state. This other state can be another one of the timed states, or a state that is not a timed state.

According to a next operation 850, a first interim command is transmitted before the TTO. In addition, other interim commands can be transmitted before the first interim command of operation 850. In the Gen 2, ACK or Req_RN can be transmitted before the first interim command of operation 850.

The first interim command can have a number of formats. In some embodiments a valid command according to the protocol can be used. In other embodiments, it can be an invalid command, as long as the first interim command causes the interim results described below.

Alternatively, a custom command can be transmitted. A custom command might have the format of HOLD or WAIT, as described later below. This adds flexibility in designing reader systems.

The importance of the choice of states relates to what the tag can do while in each state. For example, follow-up commands are described below. In some embodiments, a follow-up command will be executed by the first tag to the exclusion of the remainder of the tag population if the first tag receives the follow-up command while in the timed state, but not after the first tag has reverted to another state. A tag with which a reader is communicating, to the exclusion of other tags, is said to be singulated. Typically the reversion is to a state where the tag is “lost” to the reader, such as the Ready state of the Gen 2.

The first interim command of operation 850 causes at least one interim result on the tag. There can be more than one interim result. In some embodiments, the interim command instructs the first tag to backscatter a random number.

In some embodiments, the interim result or results includes that the first tag transitions to a different state of the protocol. In other embodiments, the interim result or results includes that the first tag remains in the same state of the protocol. For example, a custom command like HOLD or WAIT can be designed to keep the tag in the same state but not time out.

One such interim result includes a temporizing effect, of canceling that the impending default reversion will take place at the TTO. This can preserve the status of the tag, such as being singulated.

Canceling can be in a number of ways. For example, canceling can be complete, and the first interim result thus includes that the default reversion will not take place until another command is received. Such happens, for example, if the interim command causes the tag to transition to a non-timed state. Or it can be a variant of the timed state that the tag transitioned to, but the timeout is simply canceled.

As another example, canceling can extend the timeout time from TTO to ETTO. The tag may be caused to respond, transitioning to or remaining in a timed state for which there is still a timeout time ETTO, but this timeout time ETTO occurs later in time than the original TTO.

The end result is that a reader system has more time to process and decide what to do next.

In some embodiments, an interim command instructs the first tag to backscatter a random number. In those, the random number can be used as a tag identifier or “handle” for any subsequent interim commands or follow-up commands.

In the embodiments where the protocol is Gen 2, the interim command can be an acknowledge command (designated ACK), or a command that instructs the tag to backscatter a random number (this latter command is designated Req_RN). For example, while the tag is in the timed Acknowledged state, an ACK while the tag is will merely restart the T2 clock. As such, an ACK can be transmitted multiple times. For another example, a Req_RN while the tag is in the timed Acknowledged state will cause the tag to transition to states that are not timed.

According to another optional operation 860, it is determined whether the processing begun in operation 840-A can be completed before the TTO, or before another related time marker. If so, then in some embodiments the interim command of operation 850 is not transmitted. If not, then the interim command is transmitted. In fact, execution might even return to operations 850 and 860, for transmitting a second interim command, determining whether a third one is needed, and so on, as necessary to complete the processing. So, operation 850 can be repeated as necessary before the later described operations 870, 880, 890, and so on. In those cases, the second interim command can be similar to the first, in that it can be the same command but perhaps with different parameters, such as a different handle to match the latest RN16 transmitted by the tag.

According to another optional operation 870, a choice is made between a first and a second follow-up command. They are different in that the first follow-up command does not use the interim result, while the second follow-up command that uses the interim result.

In some embodiments, the choice is made in view of the first tag response received in operation 830. The choice can be as to what to do next, in view of the first tag response.

For the first and second follow-up commands, there are many possible embodiments. For example, the interim result could have been that the tag backscattered a random number, or a product code. A first follow-up command might not use the random number or product code, whereas the second might use it. More examples are described below.

Then a follow-up command is transmitted. For example, if operation 870 has taken place, the transmitted follow-up command is the chosen one. If not, the follow-up command was somehow predetermined anyway, and the interim command was sent merely to extend the time for processing.

More particularly, if, at operation 870, the decision is for the first follow-up command, then according to a next operation 880, the first follow-up command is transmitted. In some embodiments, the first follow-up command is transmitted before the TTO while the first tag is still in the timed state, and therefore does not use the interim result because it does not exploit the cancellation. In some embodiments, the first follow-up command ignores that the tag has remained in a singulated state, and continues on with inventorying other tags. In those cases, the first follow-up command can be a command that causes the tag in question to no longer be singulated, which is the very result that the interim command was trying to prevent. In the example of the Gen 2, such a result can be for the tag to transition back to the Ready state, such as with a Query, QueryRep, or QueryAdj command. It should be noted that the first follow-up command of operation 880 can be transmitted after the first interim command of operation 850, without transmitting any other intervening command.

Otherwise if, at operation 870, the decision is for the second follow-up command, then according to a next operation 890, the second follow-up command is transmitted. In some embodiments the second follow-up command is transmitted after the TTO, while the first tag is still in the timed state, and therefore uses the cancellation.

In the above, the order of operations is not constrained to what is shown, and different orders may be possible. In addition, actions within each operation can be modified, deleted, or new ones added without departing from the scope and spirit of the invention.

A benefit of the above-described methods is that, by transmitting the interim command at operation 850 before the timeout time TTO, the tag is prevented from transitioning away from the status it enjoys in the timed state, such as singulated status. This can yield additional time for the reader to determine whether the timed state will be needed or not. And if so, such additional time has been made available.

The additional time can be devoted to further processing, which can result in a system of higher performance and/or robustness, while even at high data rates. Such processing is described below.

Optional operation 840-A is related to the first tag response. Processing of the first tag response can begin before the choice of optional operation 870. In fact, processing can begin after transmitting the interim command, during, or even before. In addition, one or more parts of processing can be completed, and the choice of operation 870 can be responsive to the completed part of processing.

Processing can include many parts. Any one, or any combination of them can take place. Some are now described individually.

FIG. 8B illustrates a sample processing operation 840-B of an embodiment of operation 840-A. In this case, processing includes checking the first tag response against prior received responses. These can be for filtering data, and so on.

FIG. 8C illustrates a sample processing operation of another embodiment of operation 840-A. In this case, processing includes generating statistics about the first tag response. The statistics can be the time a code is received, how many times it was received, its signal strength, and so on.

FIG. 8D illustrates a sample processing operation of one more embodiment of operation 840-A. In this case, processing includes error checking the first tag response. Error checking can be performed in many ways, as is described, for example in co-pending U.S. patent application Ser. No. 11/388,235, filed 2006 Mar. 22, entitled “Error Recovery in RFID Reader Systems”. The disclosure of that application is hereby incorporated by reference. At least one such way is for the first tag response to include an error check code, and in which error checking includes checking the code. Another such way for error checking is to check an amplitude of a waveform segment of the backscattered wave, that encodes the first tag response, against a threshold.

Examples are now described for embodiments of the invention where the protocol is Gen 2.

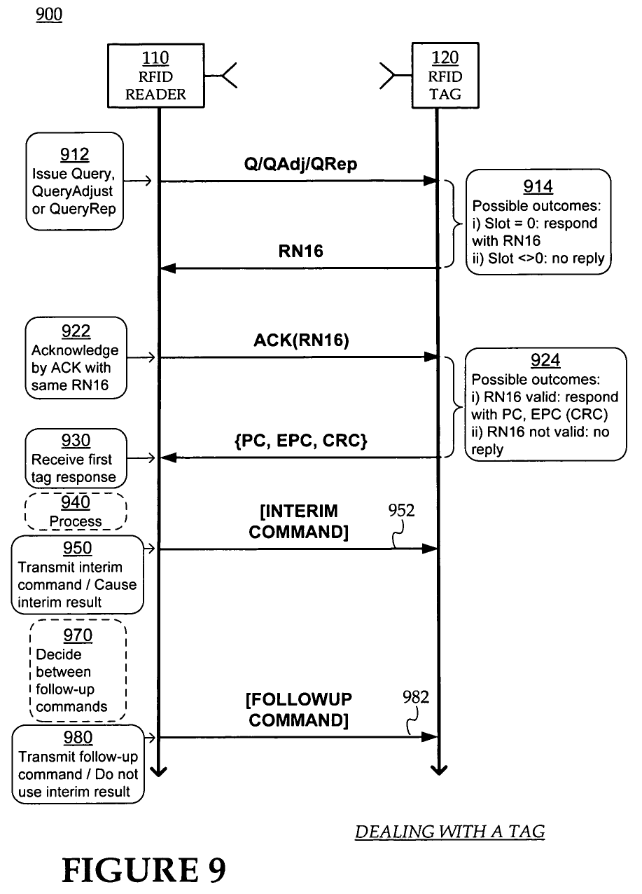

FIG. 9 is a signal flow diagram 900, resulting from the method of FIG. 8A, and also resulting from exchanges between reader 110 and tag 120.

In an action 912, reader 110 addresses one or more tags by issuing a Query, QueryAdjust or QueryRep command.

In an action 914, tag 120 has possible outcomes as shown, depending on the value then in the slot counter. If the slot value is 0, then tag 120 backscatters a random number, depicted as RN16. In the Gen 2, this has caused the tag to transition from the Arbitrate state to the Reply state.

In an action 922, upon receiving the RN16, reader 110 transmits an ACK command. Preferably the ACK command includes as parameters (or “payload”) the received RN16.

In an action 924, tag 120 receives the ACK command, and transmits a response if the RN16 is valid, i.e. the one it sent at action 914. The tag response is a Protocol Control (PC) word, an Electronic Product Code (EPC), and a Cyclic Redundancy Check (CRC), which is an error-detection code. In the Gen 2, this has caused the tag to transition from the Reply state to the Acknowledged state.

In an action 930, reader 110 receives the response that the tag sent at action 924.

In an action 940, reader 110 optionally processes the tag response it received in action 930. Processing can be as described for operation 840-A.

In an action 950 reader 110 transmits an interim command 952 to cause an interim result, similarly to operation 850. In the Gen 2, it can be a Req_RN or an ACK.

In an optional action 970, a decision is made between follow-up commands, similarly to optional operation 870. In some embodiments, the decision is made in view of the tag response received at action 930. In the example of diagram 900, the decision is for a first command that does not use the interim result caused by action 950.

In an action 980, therefore, the first follow-up command 982 is transmitted.

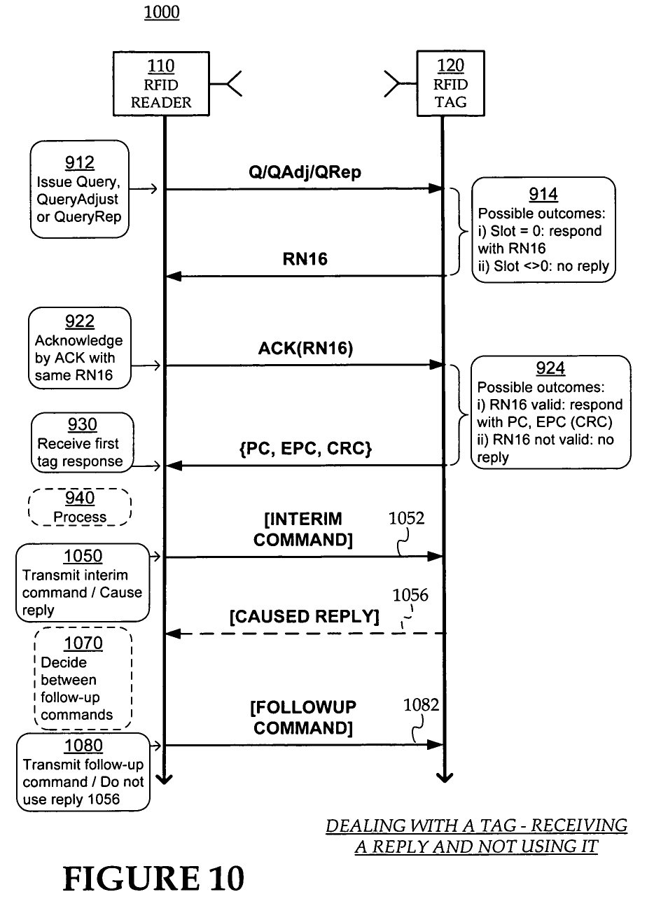

FIG. 10 is a signal flow diagram 1000, depicting an example of a flow of FIG. 9, where the interim result is a second response from a tag that is not used. More particularly, many of the early actions are the same, and their description will not be repeated.

In an action 1050, reader 110 transmits an interim command 1052, which has the particular interim result of causing a reply 1056 to be generated from a tag.

In an optional action 1070, a decision is made between follow-up commands, similarly to optional operation 870. In this case, the decision is for a first command that does not use the interim result caused by action 1050, namely the first follow-up command ignores reply 1056.

In an action 1080, therefore, the first follow-up command 1082 is transmitted.

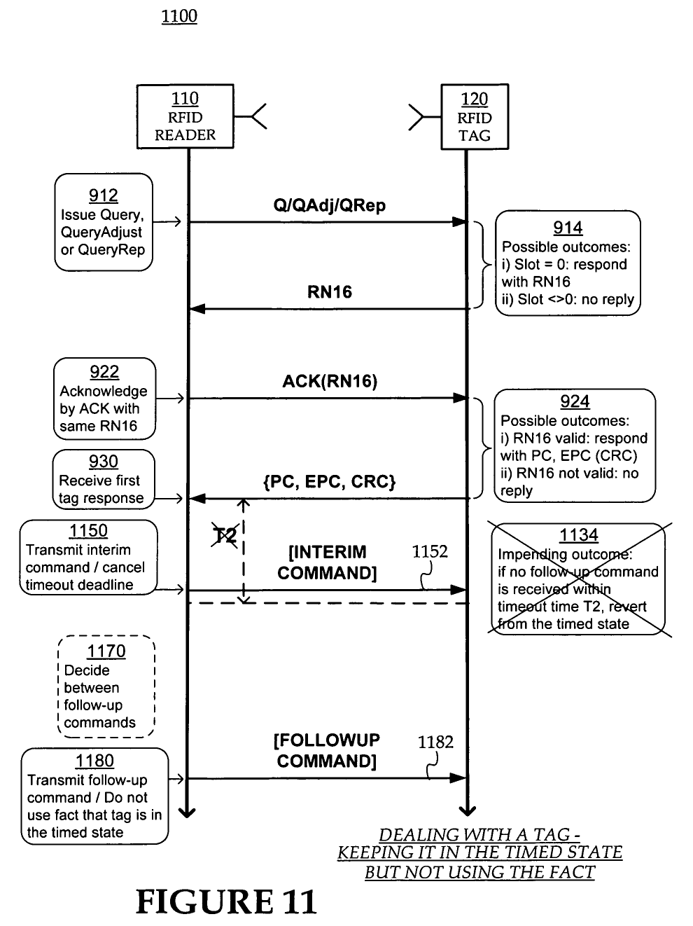

FIG. 11 is a signal flow diagram 1100, depicting an example of a flow of FIG. 9, where the interim result is canceling of a deadline to respond, and in which canceling is not used. More particularly, many of the early actions are the same, and their description will not be repeated.

In FIG. 11, when at action 930 a first tag response has been received, the tag is in a timed state. So, an action 1134 is set to occur: namely, if no follow-up command is received within timeout time T2, the tag will revert from the timed state to another state.

In an action 1150, reader 110 transmits an interim command 1152, which has the particular interim result of canceling the deadline of action 1134. That is why the above-mentioned action 1134 is shown crossed out. Interim command 1152 should be sent before time T2 expires. Of course, it should also be sent after any minimum required time window of silence.

In an optional action 1170, a decision is made between follow-up commands, similarly to optional operation 870. In this case, the decision is for a first command that does not use the interim result caused by action 1150, namely the first follow-up command ignores that the deadline of action 1134 has been canceled. Said another way, the first follow-up command functions the same as if it had been sent within timeout window T2.

In a particular Gen 2 embodiment, interim command 1152 could be another ACK command. In this case, reader 110 could receive a second response from the tag such as {PC, EPC, CRC}, which is ignored, if the first follow-up command 1182 is a Query, QueryAdj or QueryRep. A different, second follow-up command could, however, use the second response, or that the deadline has been canceled, or both.

In another Gen 2 embodiment, interim command 1152 could be a Req_RN command. In this case, reader 110 could receive a second response from the tag such as a handle, which is ignored if the first follow-up command 1182 is a Query, QueryAdj or QueryRep. A different, second follow-up command could, however, use the handle, or that the deadline has been canceled, or both. These options are described in more detail below.

FIG. 12 is a diagram 1200 showing processing by a reader system, along with the exchange of reader commands and tag responses. It will be recognized that this process can be used for singulating tags one at a time for the purpose of inventorying them.

A reader system can address tags as in operation 810, by a Query command 1210, similar to command 561 of FIG. 5D. Alternatively, the reader system can use instead a QueryAdjust command, or a QueryRep command. A tag may respond with an RN16, and transition to the Reply state. The reader system can then transmit an ACK command 1220, similar to command 562, as in operation 820. ACK command 562 places the tag in the Acknowledged state, which is a timed state. The first tag response 1230, similar to response 563, is received by the reader system, as in operation 830. After response 1230 is transmitted by the tag, the timeout time T2 begins to count down.

In the meantime, the reader system can perform processing 1240, as in operation 840, such as error checking. This processing, however, can take a long time. If the count down of T2 finishes first, the tag will revert to the Arbitrate state, and will no longer be singulated.

Accordingly, an interim command 1250 is transmitted, before the tag times out at the end of T2, as in operation 850. In this example, interim command 1250 is a Req_RN command. The Req_RN causes the tag to transition to either the open or secured states, as in FIG. 5A, neither of which is a timed state. The choice of state depends on the tag's access password. Consequently, the interim result of canceling the T2 deadline imposed by the fact that the Acknowledged state is a timed state is achieved. It is recommended that the Req_RN have a valid RN16 payload, or the tag will remain in the acknowledged state, as shown in FIG. 5C. If the RN16 is valid, the tag will also backscatter a handle in the form of a new RN16.

The reader system can optionally make a choice at 1270 between follow-up commands. In this example, a first follow-up command 1280 is a Query or QueryAdj or QueryRep, which does not use the cancellation of the deadline. In other words, the result is the same as if the reader had issued the command before timeout time 1222. The benefit of the invention, however, is that, if choice 1270 was not to access the tag, then the tag was prevented from timing out, and if it was to access the tag, then the reader system can use both the fact that that the timeout was canceled and the handle received in response to interim command 1250 to further access the tag.

The invention also includes RFID circuits and tags.

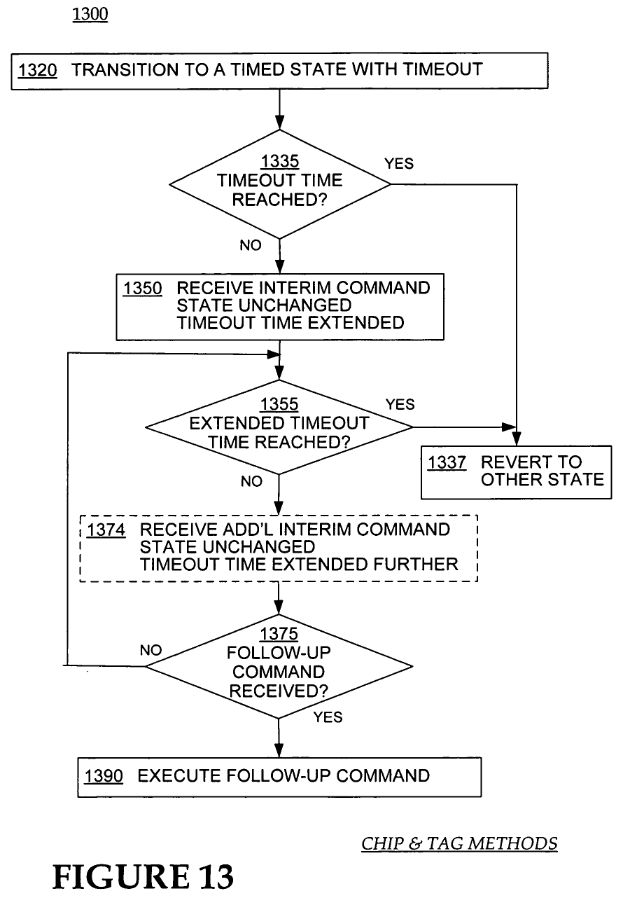

FIG. 13 is a flowchart 1300 for illustrating methods for RFID circuits and tags according to embodiments. It will be recognized that much of the description that follows is analogous to the description above, except that it is from the point of view of the tag rather than from the point of view of the reader system.

According to an operation 1320, a tag transitions to a timed state, with a timeout time TTO. This means that the tag, or just the circuit, will automatically make a default reversion to another state if it does not receive a suitable follow-up command within the timeout time TTO. The tag preferably implements this by a state machine, as per the above.

The tag can be a member of a whole population of tags. The states can be such that a follow-up command can be executed by the first tag to the exclusion of the remainder of the tag population, if the follow-up command is received by the first tag while it remains in the timed state. This is the case even though the entire tag population receives the follow-up command.

According to an operation 1335, it is inquired whether the timeout time TTO has been reached. If so, then according to another operation 1337 the tag times out, which means that it reverts to the state dictated by the state-transition tables, such as those of FIG. 5B and FIG. 5C. In that instance, any importance that the state of the tag had (e.g. being singulated) may be lost.

According to an operation 1350, a first interim command is received by the tag, which causes at least a first interim result. In the particular embodiments of flowchart 1300, the first interim result includes that the tag does not change states, but the default reversion will take place at an extended timeout time ETTO beyond the TTO.

According to a next operation 1355, it is inquired whether the extended timeout time ETTO has been reached. This is similar to operation 1335, except that the deadline has been extended. If so, the tag again reverts to the other state as per operation 1337.

According to an optional operation 1374, a second interim command is received by a reader system, which causes at least a second interim result. In the particular embodiments of flowchart 1300, the second interim result includes that the tag again does not change states, but the default reversion will take place at a further extended timeout time FETTO beyond the ETTO.

According to a next operation 1375, it is inquired whether a follow-up command has been received. If not, execution returns to operation 1355, for the ETTO or the FETTO as applicable. If yes, then the received follow-up command is executed.

In this description, numerous details have been set forth in order to provide a thorough understanding. In other instances, well-known features have not been described in detail in order to not obscure unnecessarily the description.

A person skilled in the art will be able to practice the present invention in view of this description, which is to be taken as a whole. The specific embodiments as disclosed and illustrated herein are not to be considered in any sense limiting. Indeed, it should be readily apparent to those skilled in the art that what is described herein may be modified in numerous ways. Such ways can include equivalents to what is described herein.

The following claims define certain combinations and subcombinations of elements, features, steps, and/or functions, which are regarded as novel and non-obvious. Additional claims for other combinations and subcombinations may be presented in this or a related document.

What is claimed is:

1. A radio frequency identification (RFID) reader system, comprising:
an antenna operable to exchange wireless waves with RFID tags; and
an operational processing block coupled with the antenna and operable to:
cause an RFID tag to transition from an Arbitrate state to a Reply state of the Gen2 air-interface protocol;
then cause the tag to transition from the Reply state to an Acknowledged state;
then transmit a first interim command selected from the group consisting of Req_RN and ACK; and
then, without transmitting any other intervening command, transmit a first follow-up command suitable for causing the tag to transition to a Ready state.

2. The system of claim 1, in which
when the tag transitions to the Acknowledged state, it is therefore due to make automatically a default reversion back to the Arbitrate state if it does not receive a suitable follow-up command within a preset timeout time TTO,
the first interim command is transmitted before the TTO, and cancels that the default reversion will take place at the TTO, and
the first follow-up command is transmitted after the TTO.

3. The system of claim 1, in which
the first follow-up command includes one of a Query, QueryRep, and QueryAdj commands.

4. The system of claim 1, in which the operational processing block is further operable to:
transmit a second interim command prior to transmitting the first interim command.

5. The system of claim 1, in which
the second interim command is selected from the group consisting of Req_RN and ACK.

6. The system of claim 1, in which
when the tag transitions to the Acknowledged state, it backscatters a tag code, and
the operational processing block is further operable to begin processing the backscattered tag code.

7. The system of claim 6, in which
processing begins before transmitting the first interim command.

8. The system of claim 6, in which
processing begins while transmitting the first interim command.

9. The system of claim 6, in which
processing begins after transmitting the first interim command.

10. The system of claim 6, in which
processing includes checking the backscattered tag code against prior received responses.

11. The system of claim 6, in which
processing includes generating statistics about the backscattered tag code.

12. The system of claim 6, in which
processing includes error checking the backscattered tag code.

13. The system of claim 12, in which
the backscattered tag code is followed by an error check code, and
error checking includes checking the error check code.

14. The system of claim 12, in which
error checking includes checking against a threshold an amplitude of a waveform segment of a backscattered wave that encodes the backscattered tag code.

15. A chip for a radio frequency identification (RFID) reader system that includes an antenna operable to exchange wireless waves with RFID tags, the chip including an operational processing block that is operable to cooperate with the antenna for executing operations, the operations comprising:
causing an RFID tag to transition from an Arbitrate state to a Reply state of the Gen2 air-interface protocol;
then causing the tag to transition from the Reply state to an Acknowledged state;
then transmitting a first interim command selected from the group consisting of Req_RN and ACK; and
then, without transmitting any other intervening command, transmitting a first follow-up command suitable for causing the tag to transition to a Ready state.

16. The chip of claim 15, in which
when the tag transitions to the Acknowledged state, it is therefore due to make automatically a default reversion back to the Arbitrate state if it does not receive a suitable follow-up command within a preset timeout time TTO,
the first interim command is transmitted before the TTO, and cancels that the default reversion will take place at the TTO, and
the first follow-up command is transmitted after the TTO.

17. The chip of claim 15, in which
the first follow-up command includes one of a Query, QueryRep, and QueryAdj commands.

18. The chip of claim 15, in which
when the tag transitions to the Acknowledged state, it backscatters a tag code, and
the operations further comprise beginning processing the backscattered tag code.

19. The chip of claim 18, in which
processing begins before transmitting the first interim command.

20. The chip of claim 18, in which
processing begins while transmitting the first interim command.

21. The chip of claim 18, in which
processing begins after transmitting the first interim command.

22. The chip of claim 18, in which
processing includes checking the backscattered tag code against prior received responses.

23. The chip of claim 18, in which
processing includes generating statistics about the backscattered tag code.

24. The chip of claim 18, in which
processing includes error checking the backscattered tag code.

25. An article of manufacture having stored thereon instructions which, if executed by an RFID reader system, they result in operations being performed, the operations comprising:
causing an RFID tag to transition from an Arbitrate state to a Reply state of the Gen2 air-interface protocol;
then causing the tag to transition from the Reply state to an Acknowledged state;
then transmitting a first interim command selected from the group consisting of Req_RN and ACK; and
then, without transmitting any other intervening command, transmitting a first follow-up command suitable for causing the tag to transition to a Ready state.

26. The article of claim 25, in which
when the tag transitions to the Acknowledged state, it is therefore due to make automatically a default reversion back to the Arbitrate state if it does not receive a suitable follow-up command within a preset timeout time TTO,
the first interim command is transmitted before the TTO, and cancels that the default reversion will take place at the TTO, and
the first follow-up command is transmitted after the TTO.

27. The article of claim 25, in which
the first follow-up command includes one of a Query, QueryRep, and QueryAdj commands.

28. The article of claim 25, in which the operations further comprise:
transmitting a second interim command prior to transmitting the first interim command.

29. The article of claim 28, in which
the second interim command is selected from the group consisting of Req_RN and ACK.

30. The article of claim 25, in which
when the tag transitions to the Acknowledged state, it backscatters a tag code, and
the operations further comprise beginning processing the backscattered tag code.

31. The article of claim 30, in which
processing begins before transmitting the first interim command.

32. The article of claim 30, in which
processing begins while transmitting the first interim command.

33. The article of claim 30, in which
processing begins after transmitting the first interim command.

34. The article of claim 30, in which
processing includes checking the backscattered tag code against prior received responses.

35. The article of claim 30, in which
processing includes generating statistics about the backscattered tag code.

36. The article of claim 30, in which
processing includes error checking the backscattered tag code.

37. The article of claim 36, in which
the backscattered tag code is followed by an error check code, and
error checking includes checking the error check code.

38. The article of claim 36, in which
error checking includes checking against a threshold an amplitude of a waveform segment of a backscattered wave that encodes the backscattered tag code.

39. A radio frequency identification (RFID) reader system, comprising:
antenna means for exchanging wireless waves with RFID tags; and
operational processing block means coupled with the antenna means, the operational processing block operable to:
cause an RFID tag to transition from an Arbitrate state to a Reply state of the Gen2 air-interface protocol;
then cause the tag to transition from the Reply state to an Acknowledged state;
then transmit a first interim command selected from the group consisting of Req_RN and ACK; and
then, without transmitting any other intervening command, transmit a first follow-up command suitable for causing the tag to transition to a Ready state.

40. The system of claim 39, in which
when the tag transitions to the Acknowledged state, it is therefore due to make automatically a default reversion back to the Arbitrate state if it does not receive a suitable follow-up command within a preset timeout time TTO,
the first interim command is transmitted before the TTO, and cancels that the default reversion will take place at the TTO, and
the first follow-up command is transmitted after the TTO.

41. The system of claim 39, in which
the first follow-up command includes one of a Query, QueryRep, and QueryAdj commands.

42. The system of claim 39,
in which when the tag transitions to the Acknowledged state, it backscatters a tag code, and
further comprising means for beginning processing the backscattered tag code.

43. The system of claim 42, in which
processing begins before transmitting the first interim command.

44. The system of claim 42, in which
processing begins while transmitting the first interim command.

45. The system of claim 42, in which
processing begins after transmitting the first interim command.

46. The system of claim 42, in which
processing includes checking the backscattered tag code against prior received responses.

47. The system of claim 42, in which
processing includes generating statistics about the backscattered tag code.

48. The system of claim 42, in which
processing includes error checking the backscattered tag code.

49. A method for use by a radio frequency identification (RFID) reader system, comprising:
causing an RFID tag to transition from an Arbitrate state to a Reply state of the Gen2 air-interface protocol;
then causing the tag to transition from the Reply state to an Acknowledged state;
then transmitting a first interim command selected from the group consisting of Req_RN and ACK; and
then, without transmitting any other intervening command, transmitting a first follow-up command suitable for causing the tag to transition to a Ready state.

50. The method of claim 49, in which
when the tag transitions to the Acknowledged state, it is therefore due to make automatically a default reversion back to the Arbitrate state if it does not receive a suitable follow-up command within a preset timeout time TTO,
the first interim command is transmitted before the TTO, and cancels that the default reversion will take place at the TTO, and
the first follow-up command is transmitted after the TTO.

51. The method of claim 49, in which
the first follow-up command includes one of a Query, QueryRep, and QueryAdj commands.

52. The method of claim 49, further comprising:
transmitting a second interim command prior to transmitting the first interim command.

53. The method of claim 52, in which
the second interim command is selected from the group consisting of Req_RN and ACK.

54. The method of claim 49,
in which when the tag transitions to the Acknowledged state, it backscatters a tag code, and
further comprising beginning processing the backscattered tag code.

55. The method of claim 54, in which
processing begins before transmitting the first interim command.

56. The method of claim 54, in which
processing begins while transmitting the first interim command.

57. The method of claim 54, in which
processing begins after transmitting the first interim command.

58. The method of claim 54, in which
processing includes checking the backscattered tag code against prior received responses.

59. The method of claim 54, in which
processing includes generating statistics about the backscattered tag code.

60. The method of claim 54, in which
processing includes error checking the backscattered tag code.

61. The method of claim 60, in which
the backscattered tag code is followed by an error check code, and
error checking includes checking the error check code.

62. The method of claim 60, in which
error checking includes checking against a threshold an amplitude of a waveform segment of a backscattered wave that encodes the backscattered tag code.
